(19) United States
(12) Patent Application Publication
(10) Pub. No.: US 2016/0349704 A1
(43) Pub. Date: Dec. 1, 2016

(54) INNER COMPONENT FOR TIMEPIECE PARTS

(71) Applicant: Nivarox-FAR S.A., Le Locle (CH)

(72) Inventor: Christian CHARBON, Chezard-St-Martin (CH)

(73) Assignee: Nivarox-FAR S.A., Le Locle (CH)

(21) Appl. No.: 15/141,025

(22) Filed: Apr. 28, 2016

(30) Foreign Application Priority Data
May 27, 2015 (EP) 15169387.6

(51) Int. Cl. G04B 19/12; C22C 9/06; G04D 3/00

(52) U.S. Cl. CPC G04B 19/12; G04D 3/0048; C22C 9/06

(57) ABSTRACT

Utilisation of a single phase alloy with a face-centred cubic structure including at least copper and nickel, and including a total mass percentage of copper and nickel greater than or equal to 50%, for making an inner component for timepiece parts, this alloy including a mass proportion of copper greater than or equal to 50% and/or a mass proportion of nickel greater than or equal to 15.0% of the total mass in which case this alloy includes a mass proportion of manganese less than or equal to 2.0%. Method for fabrication of an inner component for timepiece parts which is of determined shape and dimensions, in which method there is taken a raw material made of such an alloy and this raw material is machined to obtain an inner component for timepiece parts with the finished dimensions corresponding to these determined shape and dimensions.

This application claims priority from European Patent Application No. 15169387.6 filed on May 27, 2015, the entire disclosure of which is hereby incorporated herein by reference.

### FIELD OF THE INVENTION

The invention concerns the use of a single phase alloy with a face-centred cubic structure comprising at least copper and nickel, and including a total mass percentage of copper and nickel greater than or equal to 50%, for making an inner component for timepiece parts.

The invention also concerns a method for fabrication of an inner component for timepiece parts which is of determined shape and dimensions, wherein there is taken a sheet or strip or bar of raw material, made of single phase alloy with a face-centred cubic structure including at least copper and including, a total mass percentage of copper and nickel greater than or equal to 50%.

The invention concerns the field of inner components for timepiece parts, particularly for watches.

### BACKGROUND OF THE INVENTION

The fabrication of the external timepiece parts requires great care, as these components are highly visible and affect the image of the manufacturer's brand and market position.

Although the external parts are necessarily made of stable, corrosion resistant materials which must ensure low nickel salting out because they are in contact with the user's skin, the inner components of the parts, which are confined inside the timepiece but visible through a crystal, permit the use of more varied materials.

There are therefore known inner components for parts, particularly appliques, made of rhodium-plated brass. These components have a very satisfactory appearance, provided they are very carefully protected during handling and assembly, due to the fragile nature of the coating which is generally produced by an electroplating treatment that accentuates any defect existing prior to the treatment.

FR Patent 1049188 in the name of Straumann describes parts for timepiece devices made of hardenable alloy, with total nickel and manganese content of at least 50%, the remainder being formed by copper and the usual impurities. Several examples also mention a total copper and nickel content of at least 50%.

### SUMMARY OF THE INVENTION

To this end, the invention concerns the utilisation of a single phase alloy with a face-centred cubic structure comprising at least copper and nickel, and including a total mass percentage of copper and nickel greater than or equal to 50%, for making an inner component for timepiece parts.

The invention also concerns a method for fabrication of an inner component for timepiece parts which is of determined shape and dimensions, according to claim 2.

### BRIEF DESCRIPTION OF THE DRAWINGS

Other features and advantages of the invention will appear upon reading the following detailed description, with reference to the annexed drawings, in which:

FIGS. 1 to 4 show schematic, respectively top perspective, bottom perspective, top and longitudinal cross-sectional views of an inner component for timepiece parts, in the specific case of an applique;

FIG. 5 shows a schematic view of a watch including such appliques.

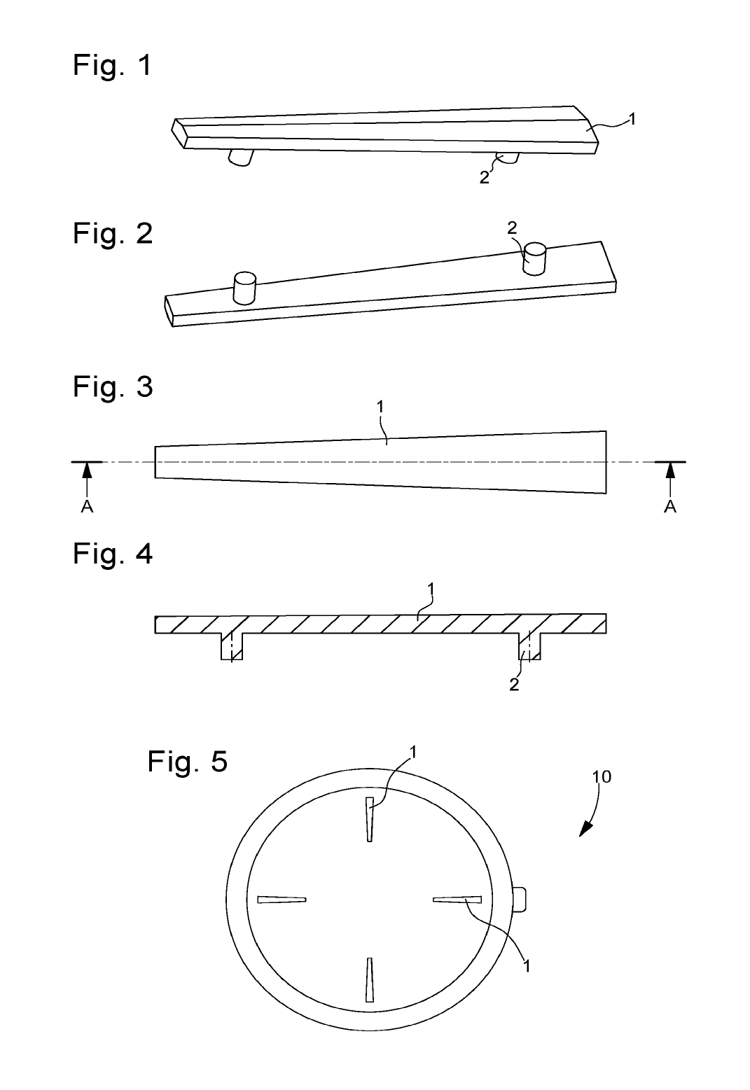

### DETAILED DESCRIPTION OF PREFERRED EMBODIMENTS

An “inner component for timepiece parts” means here any component of the part of a watch or of a timepiece, which is visible to the user, but not immediately accessible, since it is protected by a crystal or protective wall, back cover or similar.

More specifically, an inner component for timepiece parts may consist of an applique, a hand, a symbol, a setting, or suchlike.

The invention concerns the utilisation of a single phase alloy with a face-centred cubic structure comprising at least copper and nickel, and including a total mass percentage of copper and nickel greater than or equal to 50%, for making such an inner component 1 for timepiece parts.

According to the invention, said alloy includes a mass proportion of copper greater than or equal to 50%, and/or a mass proportion of nickel greater than or equal to 15.0% of the total mass, in which case said alloy includes a mass proportion of manganese less than or equal to 2.0%.

More specifically, when this alloy has a mass proportion of nickel greater than or equal to 15.0%, it includes a mass proportion of at least 8.0% of zinc and/or of at least 50% of nickel.

More specifically still, in order to make an inner component 1 for timepiece parts, there is used an alloy which is either a cupronickel including between 15.0 and 30.0 mass percent of nickel, and including from 0.0 to 2.0 mass percent of manganese and/or of iron and/or of chromium and/or of zirconium and/or of silicon, or a nickel silver alloy comprising at least 8.0 mass percent of zinc.

More specifically, the alloy is either a cupronickel including between 20.0 and 30.0 mass percent of nickel, and including from 0.0 to 2.0 mass percent of manganese and/or of iron and/or of chromium and/or of zirconium and/or of silicon, or a nickel silver alloy comprising at least 8.0 mass percent of zinc.

To overcome any known surface state problems for components that have an electroplating treatment, the invention proposes to dispense with any electroplating treatment, and to make an inner component for timepiece parts that is immediately usable in its post-machining state.

The word “machining” covers here the usual methods of production: stamping, cutting, removal of cuttings, precision grinding, lapping, polishing, diamond polishing, and suchlike.

These components are therefore made from a material which is capable of being machined, stamped, cut, diamond polished, is ductile (in particular for forging the legs in the case of machining a strip), has a uniform colour and especially is resistant to tarnishing and very stable over time.

The uniform colour desired is usually grey, or gold: yellow gold, white gold or rose gold.

The invention also concerns a method for fabrication of such an inner component 1 for timepiece parts which is of determined shape and dimensions.

According to the invention, there is taken a sheet or strip or bar of raw material made from a single phase alloy with a face-centred cubic structure including a total mass percentage of copper and nickel greater than or equal to 50%, and the raw material is machined to obtain an inner component 1 for timepiece parts with finished dimensions that correspond to said determined shape and dimensions.

This machining is effected by stamping and/or cutting and/or pressing and/or removal of cuttings, and inner component 1 for timepiece parts is diamond polished to the finished dimensions, and component 1 is used fresh from diamond polishing and without any electroplating treatment or coating.

According to the invention, this alloy is selected to include at least copper, and to include a mass proportion of copper greater than or equal to 50%, and/or a mass proportion of nickel greater than or equal to 15.0% in which case the alloy preferably includes a mass proportion of manganese less than or equal to 2.0%.

Various suitable alloy compositions meeting this definition are set out below.

More specifically, the alloy is selected to be either a cupronickel including between 15.0 and 30.0 mass percent of nickel, and including from 0.0 to 2.0 mass percent of manganese and/or of iron and/or of chromium and/or of zirconium and/or of silicon, or a nickel silver alloy comprising at least 8.0 mass percent of zinc.

More specifically still, the alloy is selected to be either a cupronickel including between 20.0 and 30.0 mass percent of nickel, and including from 0.0 to 2.0 mass percent of manganese and/or of iron and/or of chromium and/or of zirconium and/or of silicon, or a nickel silver alloy comprising at least 8.0 mass percent of zinc.

More specifically, to implement this method, there is selected an alloy with a mass proportion of nickel greater than or equal to 15% of the total mass.

In a particular advantageous embodiment, this alloy includes at least one element limiting tarnishing, chosen from nickel, manganese, aluminium, tin, chromium, zirconium or suchlike.

More specifically, the mass proportion of nickel is greater than or equal to 19.0% of the total mass.

In an alternative, the mass proportion of copper in this alloy is greater than or equal to 50.0% of the total mass.

In another alternative, the mass proportion of nickel in this alloy is greater than or equal to 50.0% of the total mass.

More specifically, in a first embodiment, the alloy includes at least 50 mass percent of copper, and the alloy is chosen to include nickel in a mass proportion greater than or equal to 15.0% of the total mass.

More specifically, the selected alloy is thus a cupronickel, including between 19.0 and 30.0 mass percent of nickel, and including from 0.0 to 2.0 mass percent of manganese and/or of iron and/or of chromium and/or of zirconium and/or of silicon, and a mass proportion of copper bringing the total composition to 100%.

In a first cupronickel variant, the alloy includes between 19.0 and 23.0 mass percent of nickel, and includes from 0.0 to 1.0 mass percent of zinc and/or of manganese and/or of iron, and a mass proportion of copper bringing the total composition to 100%.

In a second cupronickel variant, of the CuNi25 type, the alloy includes between 24.0 and 26.0 mass percent of nickel, and includes from 0.0 to 0.5 mass percent of zinc and/or of manganese and/or of iron, and a mass proportion of copper bringing the total composition to 100%.

In a third cupronickel variant, of the CuNi30 type, the alloy includes between 29.0 and 32.0 mass percent of nickel, and includes from 0.0 to 0.5 mass percent of zinc and/or of manganese and/or of iron, and a mass proportion of copper bringing the total composition to 100%.

In one of these cupronickel variants, the alloy more specifically includes between 0.5 and 5.0 mass percent of tin to improve its resistance to tarnishing.

In a second embodiment, the alloy is a nickel silver with a mass proportion of zinc greater than or equal to 8.0% of the total mass. More specifically, the alloy has a mass proportion of nickel greater than or equal to 20% of the total mass, and a mass proportion of copper bringing the total composition to 100%. More specifically, the mass proportion of copper in this alloy is greater than or equal to 50.0% of the total mass.

In a first nickel silver variant, the alloy includes a mass proportion of zinc of at least 11% of the total mass.

In a second nickel silver variant, the alloy includes a mass proportion of nickel of at least 25.0% of the total mass.

In a third nickel silver variant, the alloy includes both a mass proportion of zinc of at least 11% of the total mass and a mass proportion of nickel of at least 25.0% of the total mass.

In a fourth nickel silver variant, the alloy is an ARCAP including a mass proportion of copper of at least 53.0% of the total mass, a mass proportion of nickel of at least 25.0% of the total mass, and a mass proportion of zinc comprised between 8.0 and 20.0% of the total mass.

In a fifth nickel silver variant, the alloy is an ARCAP of the AP1D type including a mass proportion of copper comprised between 60.0% and 61.0% of the total mass, a mass proportion of nickel comprised between 24.0% and 26.0% of the total mass, and a mass proportion of zinc comprised between 11.0% and 12.0% of the total mass.

In a sixth nickel silver variant, the alloy is an ARCAP of the AP1D type including a mass proportion of copper comprised between 60.0% and 61.0% of the total mass, a mass proportion of nickel comprised between 24.0% and 26.0% of the total mass, and a mass proportion of zinc comprised between 11.0% and 12.0% of the total mass, and from 0 to 2.5% of another element. More specifically, this other element is manganese.

In a third embodiment, this alloy is of the CuNiMn type, i.e. a copper-nickel-manganese alloy, with a mass proportion of manganese comprised between 19.0 and 31.0% of the total mass.

More specifically, this copper-nickel-manganese alloy includes a mass proportion of nickel comprised between 19.0 and 31.0% of the total mass.

In a fourth embodiment, this alloy is of the Monel® type.

In a first Monel® variant, the alloy includes a mass proportion of nickel greater than or equal to 63.0% of the total mass, a proportion of manganese less than or equal to 2.0% of the total mass, a proportion of iron less than or equal to 2.5% of the total mass, a proportion of silicon less than or equal to 0.5% of the total mass, a proportion of carbon less than or equal to 0.3% of the total mass, a proportion of sulphur less than or equal to 0.02% of the total mass, a mass proportion of copper comprised between 28.0 and 34.0% of the total mass and such that the total composition is equal to 100%.

In a second Monel® variant, the alloy includes a mass proportion of nickel greater than or equal to 63.0% of the total mass, a proportion of manganese less than or equal to 1.5% of the total mass, a proportion of iron less than or equal to 2.0% of the total mass, a proportion of silicon less than or equal to 0.5% of the total mass, a proportion of carbon less than or equal to 0.25% of the total mass, a proportion of sulphur less than or equal to 0.01% of the total mass, a mass proportion of aluminium comprised between 2.3 and 3.15% of the total mass, a mass proportion of titanium comprised between 0.35 and 0.75% of the total mass, a mass proportion of copper comprised between 27.0 and 33.0% of the total mass and such that the total composition is equal to 100%.

All of the alloys chosen above make it possible to obtain a uniform grey colour compatible with numerous horological uses.

It is also possible to use gold and 5N gold coloured alloys. For yellow gold, suitable alloys are Nordic gold, Cu89Al5Zn5Sn1, and the alloy Cu92Al6Ni2, or other cupro-aluminium type alloys. These alloys are also single-phase copper-based alloys, and the resistance to tarnishing and yellow colour are obtained by the addition of aluminium.

The invention concerns a component 1 thereby formed for an part and ready to use after diamond polishing.

The invention also concerns a timepiece, particularly a watch 10, including at least one such component 1 for an part.

1. An utilisation of a single phase alloy with a face-centred cubic structure comprising at least copper and nickel, and including a total mass percentage of copper and nickel greater than or equal to 50%, for making an inner component for timepiece parts, wherein said alloy includes a mass proportion of copper greater than or equal to 50% and/or a mass proportion of nickel greater than or equal to 15.0% of the total mass in which case said alloy includes a mass proportion of manganese less than or equal to 2.0%.

2. The utilisation of a single phase alloy according to claim 1, wherein said alloy has a mass proportion of nickel greater than or equal to 15.0%, and a mass proportion of at least 8.0% of zinc and/or of at least 50% of nickel.

3. The utilisation of a single phase alloy according to claim 1, wherein said alloy is either a cupronickel including between 20.0 and 30.0 mass percent of nickel, and including from 0.0 to 2.0 mass percent of manganese and/or of iron and/or of chromium and/or of zirconium and/or of silicon, or a nickel silver alloy comprising at least 8.0 mass percent of zinc.

4. A method for fabrication of an inner component for timepiece parts which is of determined shape and dimensions, wherein there is taken a sheet or strip or bar of raw material, made of single phase alloy with a face-centred cubic structure including at least copper and including a total mass percentage of copper and nickel greater than or equal to 50%, wherein said raw material is machined to obtain an inner component for timepiece parts with finished dimensions that correspond to said determined shape and dimensions, wherein said machining is effected by stamping and/or cutting and/or pressing and/or removal of cuttings, and wherein said inner component for timepiece parts is diamond polished to the finished dimensions, and wherein said component is used fresh from diamond polishing and without any electroplating or coating, and wherein said alloy is chosen to include a mass proportion of copper greater than or equal to 50% and/or a mass proportion of nickel greater than or equal to 15.0% of the total mass, in which case said alloy includes a mass proportion of manganese less than or equal to 2.0%.

5. The method according to claim 4, wherein said alloy is selected with a mass proportion of nickel greater than or equal to 15.0% of the total mass, and in that said alloy includes a mass proportion of either at least 8.0% of zinc or of at least 50% of nickel.

6. The method according to claim 4, wherein said alloy is selected with a mass proportion of nickel greater than or equal to 15.0% of the total mass, said alloy either being a cupronickel including between 20.0 and 30.0 mass percent of nickel and including from 0.0 to 2.0 mass percent of manganese and/or of iron and/or of chromium and/or of zirconium and/or of silicon, or a nickel silver alloy comprising at least 8.0 mass percent of zinc.

7. The method according to claim 5, wherein said alloy is selected to be a Monel®, with a mass proportion of nickel greater than or equal to 63.0% of the total mass, a proportion of manganese less than or equal to 2.0% of the total mass, a proportion of iron less than or equal to 2.5% of the total mass, a proportion of silicon less than or equal to 0.5% of the total mass, a proportion of carbon less than or equal to 0.3% of the total mass, a proportion of sulphur less than or equal to 0.02% of the total mass, a mass proportion of copper comprised between 28.0 and 34.0% of the total mass and such that the total composition is equal to 100%.

8. The method according to claim 5, wherein said alloy is selected to be a Monel®, with a mass proportion of nickel greater than or equal to 63.0% of the total mass, a proportion of manganese less than or equal to 1.5% of the total mass, a proportion of iron less than or equal to 2.0% of the total mass, a proportion of silicon less than or equal to 0.5% of the total mass, a proportion of carbon less than or equal to 0.25% of the total mass, a proportion of sulphur less than or equal to 0.01% of the total mass, a mass proportion of aluminium comprised between 2.3 and 3.15% of the total mass, a mass proportion of titanium comprised between 0.35 and 0.75% of the total mass, a mass proportion of copper comprised between 27.0 and 33.0% of the total mass and such that the total composition is equal to 100%.

9. The method according to claim 4, wherein said alloy is selected to include at least 50 mass percent of copper, and in that said alloy is chosen to include nickel in a mass proportion greater than or equal to 15.0% of the total mass.

10. The method according to claim 9, wherein said alloy is selected to be a cupronickel, including between 19.0 and 30.0 mass percent of nickel, and including from 0.0 to 2.0 mass percent of manganese and/or of iron and/or of chromium and/or of zirconium and/or of silicon, and a mass proportion of copper bringing the total composition to 100%.

11. The method according to claim 9, wherein said alloy is selected to be a cupronickel, including between 19.0 and 23.0 mass percent of nickel, and including from 0.0 to 2.0 mass percent of zinc and/or of manganese and/or of iron, and a mass proportion of copper bringing the total composition to 100%.

12. The method according to claim 9, wherein said alloy is selected to be a cupronickel, including between 24.0 and 26.0 mass percent of nickel, and including from 0.0 to 0.5 mass percent of zinc and/or of manganese and/or of iron, and a mass proportion of copper bringing the total composition to 100%.

13. The method according to claim 9, wherein said alloy is selected to be a cupronickel, including between 29.0 and 32.0 mass percent of nickel, and including from 0.0 to 0.5 mass percent of zinc and/or of manganese and/or of iron, and a mass proportion of copper bringing the total composition to 100%.

14. The method according to claim 9, wherein said alloy includes between 0.5 and 5.0 mass percent of tin to improve the resistance thereof to tarnishing.

15. The method according to claim 4, wherein said alloy is selected to include at least 50 mass percent of copper, and in that said alloy is chosen to be of the cupro-aluminium or Cu89Al5Zn5Sn1 or Cu92Al6Ni2 type.

16. The method according to claim 5, wherein said alloy is selected to include at least 8 mass percent of zinc.

17. The method according to claim 16, wherein said alloy is selected to be a nickel silver, with a mass proportion of zinc greater than or equal to 8% of the total mass, with a mass proportion of nickel greater than or equal to 20% of the total mass, and a mass proportion of copper bringing the total composition to 100%.

18. The method according to claim 16, wherein the mass proportion of copper in said alloy is greater than or equal to 50.0% of the total mass.

19. The method according to claim 17, wherein said nickel silver has a mass proportion of zinc of at least 11% of the total mass.

20. The method according to claim 16, wherein said alloy is selected to be a nickel silver with a mass proportion of nickel of at least 25% of the total mass.

21. The method according to claim 16, wherein said alloy is selected to be a nickel silver which is an ARCAP including a mass proportion of copper of at least 53.0% of the total mass, a mass proportion of nickel of at least 25.0% of the total mass, and a mass proportion of zinc comprised between 8.0 and 20.0% of the total mass.

22. The method according to claim 16, wherein said alloy is selected to be a nickel silver which is an ARCAP of the AP1D type including a mass proportion of copper comprised between 60.0% and 61.0% of the total mass, a mass proportion of nickel comprised between 24.0% and 26.0% of the total mass, and a mass proportion of zinc comprised between 11.0 and 12.0% of the total mass.

23. The method according to claim 4, wherein said alloy includes at least one element limiting tarnishing, chosen from nickel, manganese, aluminium, tin, chromium and zirconium.

24. The method according to claim 4, wherein said inner component for an part made by said method is incorporated inside a watch or a timepiece, in an area having no contact with the user.
